(19) United States
(12) Patent Application Publication
(10) Pub. No.: US 2011/0158887 A1
(43) Pub. Date: Jun. 30, 2011

(54) Apparatus and method of use for casting system with independent melting and solidification

(75) Inventors: Nathan G. Stoddard, Gettysburg, PA (US); James A. Cliber, Emmitsburg, MD (US); Roger F. Clark, Knoxville, MD (US); Bei Wu, Frederick, MD (US); Soham Dey, Hillsboro, OR (US); Douglas L. Stark, Mt. Airy, MD (US)

(73) Assignee: AMG IdealCast Solar Corporation, Frederick, MD (US)

(21) Appl. No.: 13/061,081

(22) PCT Filed: Aug. 21, 2009
(86) PCT No.: PCT/US2009/054564

§ 371 Date: Feb. 25, 2011

Related U.S. Application Data
(60) Provisional application No. 61/092,186, filed on Aug. 27, 2008.

(51) Int. Cl. C01B 33/02; F27D 3/00; F27B 14/02; F27B 14/04; F27B 14/06; B29C 39/02; B29C 39/38

(52) U.S. Cl. 423/348; 432/239; 432/75; 432/13; 432/2; 219/635; 219/162; 432/263; 432/1; 425/470; 264/319

(57) ABSTRACT

This invention relates to a two or three-stage apparatus and method of use to produce high purity silicon, such as for use in solar panels and/or photovoltaics. The device of this invention includes a melting apparatus with a delivery device, a holding apparatus with a tipping or transfer mechanism, and at least one solidification apparatus for receiving a molten feedstock. The optimized designs of individual apparatuses function efficiently in combination to produce high purity silicon.

This application claims the benefit of priority from U.S. Provisional Patent Application No. 61/092,186 filed Aug. 27, 2008, the entirety of which is expressly incorporated herein by reference.

### BACKGROUND

1. Technical Field

This invention relates to apparatuses and methods of use with independent melting and solidification for producing high purity silicon, such as for use in solar modules.

2. Discussion of Related Art

Photovoltaic cells convert light into electric current. One of the most important features of a photovoltaic cell is its efficiency in converting light energy into electrical energy. Although photovoltaic cells can be fabricated from a variety of semiconductor materials, silicon is generally used because it is readily available at reasonable cost, and because it has a suitable balance of electrical, physical, and chemical properties for use in fabricating photovoltaic cells.

In a known procedure for the manufacture of photovoltaic cells, silicon feedstock is doped with a dopant having either a positive or negative conductivity type, melted, and then crystallized by pulling crystallized silicon out of a melt zone into ingots of monocrystalline silicon (via the Czochralski (CZ) or float zone (FZ) methods). For a FZ process, solid material is fed through a melting zone, melted upon entry into one side of the melting zone, and re-solidified on the other side of the melting zone, generally by contacting a seed crystal.

Recently, a new technique for producing monocrystalline or geometric multicrystalline material in a crucible solidification process (i.e. a cast-in-place or casting process) has been invented, as disclosed in U.S. patent application Ser. Nos. 11/624,365 and 11/624,411, and published in U.S. Patent Application Publication Nos. 20070169684A1 and 20070169685A1, filed Jan. 18, 2007. Casting processes for preparing multicrystalline silicon ingots are known in the art of photovoltaic technology. Briefly, in such processes, molten silicon is contained in a crucible, such as a quartz crucible, and is cooled in a controlled manner to permit the crystallization of the silicon contained therein. The block of cast crystalline silicon that results is generally cut into bricks having a cross-section that is the same as or close to the size of the wafer to be used for manufacturing a photovoltaic cell, and the bricks are sawn or otherwise cut into such wafers. Multi-crystalline silicon produced in such manner is composed of crystal grains where, within the wafers made therefrom, the orientation of the grains relative to one another is effectively random. Monocrystalline or geometric multicrystalline silicon has specifically chosen grain orientations and (in the latter case) grain boundaries, and can be formed by the new casting techniques disclosed in the above-mentioned patent applications by melting in a crucible the solid silicon into liquid silicon in contact with a large seed layer that remains partially solid during the process and through which heat is extracted during solidification, all while remaining in the same crucible. As used herein, the term ‘seed layer’ refers to a crystal or group of crystals with desired crystal orientations that form a continuous layer. They can be made to conform to one side of a crucible for casting purposes.

In order to produce high quality cast ingots, several conditions should be met. Firstly, as much of the ingot as possible should have the desired crystallinity. If the ingot is intended to be monocrystalline, then the entire usable portion of the ingot should be monocrystalline, and likewise for geometric multicrystalline material. Secondly, the silicon should contain as few imperfections as possible. Imperfections can include individual impurities, agglomerates of impurities, intrinsic lattice defects and structural defects in the silicon lattice, such as dislocations and stacking faults. Many of these imperfections can cause a fast recombination of electrical charge carriers in a functioning photovoltaic cell made from crystalline silicon. This can cause a decrease in the efficiency of the cell.

Many years of development have resulted in a minimal amount of imperfections in well-grown CZ and FZ silicon. Dislocation free single crystals can be achieved by first growing a thin neck where all dislocations incorporated at the seed are allowed to grow out. The incorporation of inclusions and secondary phases (for example silicon nitride, silicon oxide or silicon carbide particles) is avoided by maintaining a counter-rotation of the seed crystal relative to the melt. Oxygen incorporation can be lessened using magnetic CZ techniques and minimized using FZ techniques as is known in the industry. Metallic impurities are generally minimized by being segregated to the tang end or left in the potscrap after the boule is brought to an end. However, even with the above improvements in the CZ and FZ processes, there is a need and a desire to produce high purity crystalline silicon that is less expensive on a per volume basis, needs less capital investment in facilities, needs less space, and/or less complexity to operate, than known CZ and FZ processes.

### SUMMARY

This invention relates to an apparatus and a method of use for a casting system with independent melting and solidification. Other benefits of the invention may include a high purity crystalline silicon that is less expensive on a per volume basis, needs less capital investment in facilities, needs less space, and/or less complexity to operate, than known CZ and FZ processes.

According to a first embodiment, this invention includes a melting apparatus suitable for producing high purity silicon. The melting apparatus includes a heat source for melting a solid feedstock, a delivery device for supplying the solid feedstock to the heat source, and a catch pan for receiving a molten feedstock from the heat source and flowing the molten feedstock to a holding apparatus or further processing.

According to a second embodiment, this invention includes a method of melting a solid feedstock suitable for producing high purity silicon. The method of melting includes providing a solid feedstock, supplying the solid feedstock with a delivery device to a heat source, melting the solid feedstock with the heat source, and receiving a molten feedstock from the heat source in a catch pan for flowing the molten feedstock to further processing or staging.

According to a third embodiment, this invention includes a holding apparatus suitable for producing high purity silicon. The holding apparatus includes a holding vessel with an outlet for receiving a molten feedstock, at least one heater, and a tipping or transfer mechanism for flowing the molten feedstock to further processing or staging.

According to a fourth embodiment, this invention includes a method of using a holding apparatus suitable for producing high purity silicon. The method of using includes receiving a molten feedstock into a holding vessel, maintaining the molten feedstock at or above a feedstock melting point, and transferring the molten feedstock through an outlet.

According to a fifth embodiment, this invention includes a solidification apparatus suitable for producing high purity silicon. The solidification apparatus includes a crucible or vessel for receiving a molten feedstock from a trough, at least one heater, and at least one heat sink.

According to a sixth embodiment, this invention includes a method of solidifying a molten feedstock suitable for producing high purity silicon. The method of solidifying includes providing a molten feedstock, receiving the molten feedstock in a crucible, heating the molten feedstock with a heater to control a temperature within the crucible, and cooling the molten feedstock from at least a bottom to crystallize the molten feedstock.

According to a seventh embodiment, this invention includes a three-stage apparatus suitable for producing high purity silicon. The three-stage apparatus includes a melting apparatus for melting a solid feedstock to a molten feedstock, a holding apparatus for receiving the molten feedstock from the melting apparatus, and at least one solidification apparatus for solidifying the molten feedstock into a solid product.

According to an eighth embodiment, this invention includes a method suitable for producing high purity silicon with a three-stage apparatus. The method of producing includes providing a solid feedstock, loading the solid feedstock into a melting apparatus, melting the solid feedstock in the melting apparatus to a molten feedstock, transferring the molten feedstock to a holding apparatus, flowing molten feedstock into a solidification apparatus from the holding apparatus, and solidifying the molten feedstock to a solid product in a crucible of the solidification apparatus.

According to a ninth embodiment, this invention includes a high purity silicon ingot made by a three-stage method. The three stages include a melting stage, a holding stage, and a solidifying stage. The method used to produce the ingot includes providing a solid feedstock including silicon, loading the solid feedstock into a melting apparatus, melting the solid feedstock in the melting apparatus to a molten feedstock. The method used to produce the ingot includes transferring the molten feedstock to a holding apparatus, flowing the molten feedstock into a solidification apparatus from the holding apparatus, and solidifying the molten feedstock to a solid product in a crucible of the solidification apparatus.

### BRIEF DESCRIPTION OF THE DRAWINGS

The accompanying drawings, which are incorporated in and constitute a part of this specification, illustrate embodiments of the invention and, together with the description, serve to explain the features, advantages, and principles of the invention. In the drawings:

FIG. 1 illustrates an integrated melting apparatus, holding apparatus, and solidifying apparatus, according to one embodiment;

FIG. 2 illustrates a melting apparatus, according to one embodiment;

FIG. 3 illustrates a partial side sectional view of a melting apparatus, according to one embodiment;

FIG. 4 illustrates a holding apparatus, according to one embodiment;

FIG. 5 illustrates a solidification apparatus, according to one embodiment;

FIG. 6 illustrates a partial side sectional view of a solidification apparatus, according to one embodiment; and

FIG. 7 illustrates multiple layouts of melting apparatuses, holding apparatuses, and solidification apparatuses, according to one embodiment.

### DETAILED DESCRIPTION

This invention relates to an apparatus and methods of use for producing high purity silicon, such as for production of photovoltaics or use in solar applications. Solar applications include solar panels, solar modules, solar arrays, solar grids, and/or any other suitable devices for capturing at least a portion of the electromagnetic spectrum, such as infrared, visible, and/or ultraviolet wavelengths. Desirably, the solar applications include devices for capturing energy from the sun.

High purity silicon broadly includes compositions of matter including primarily silicon, such as at least about 95 weight percent, at least about 99 weight percent, at least about 99.999 weight percent, and/or any other suitable amount. Desirably, but not necessarily, the high purity silicon may further include a dopant, such as to modify the electrical properties of the material. High purity silicon includes material that has been at least partially refined and/or has less contaminants than silicon ore (silicon oxide) and/or metallurgical grade silicon. High purity silicon may include semiconductor grade materials. In the alternative, the high purity silicon may exclude semiconductor grade materials, such as having sufficient purity for solar grade silicon.

Moreover, although casting of silicon has been described herein, other semiconductor materials and nonmetallic crystalline materials may be cast without departing from the scope and spirit of the invention. For example, the inventors have contemplated casting of other materials consistent with embodiments of the invention, such as germanium, gallium arsenide, silicon germanium, aluminum oxide (including its single crystal form of sapphire), gallium nitride, zinc oxide, zinc sulfide, gallium indium arsenide, indium antimonide, germanium, yttrium barium oxides, lanthanide oxides, magnesium oxide, calcium oxide, and other semiconductors, oxides, and intermetallics with a liquid phase. In addition, a number of other group III-V or group II-VI materials, as well as metals and alloys, could be cast according to embodiments of the present invention.

Cast silicon includes multicrystalline silicon, near multicrystalline silicon, geometric multicrystalline silicon, and/or monocrystalline silicon. Multicrystalline silicon refers to crystalline silicon having about a centimeter scale grain size distribution, with multiple randomly oriented crystals located within a body of multicrystalline silicon.

Geometric multicrystalline silicon or geometrically ordered multicrystalline silicon refers to crystalline silicon having a nonrandom ordered centimeter scale grain size distribution, with multiple ordered crystals located within a body of multicrystalline silicon. The geometric multicrystalline may include grains typically having an average about 0.5 centimeters to about 5 centimeters in size and a grain orientation within a body of geometric multicrystalline silicon can be controlled according to predetermined orientations, such as using a combination of suitable seed crystals.

Polycrystalline silicon refers to crystalline silicon with micrometer to millimeter scale grain size and multiple grain orientations located within a given body of crystalline silicon. Polycrystalline silicon may include grains typically having an average of about submicron to about micron in size (e.g., individual grains are not visible to the naked eye) and a grain orientation distributed randomly throughout.

Monocrystalline silicon refers to crystalline silicon with very few grain boundaries since the material has generally and/or substantially the same crystal orientation. Monocrystalline material may be formed with one or more seed crystals, such as a piece of crystalline material brought in contact with liquid silicon during solidification to set the crystal growth. Near monocrystalline silicon refers to generally crystalline silicon with more grain boundaries than monocrystalline silicon but generally substantially fewer than multicrystalline silicon.

This invention includes a system for the casting silicon that significantly reduces the capital intensity of a furnace while dramatically increasing the throughput and/or the ingot quality. The advantages over conventional practices may include: 1. a reduced cycle time by allowing simultaneous melting and solidification (i.e. melting the next charge while solidifying the current one); 2. improved ingot quality since the melting processes and the solidification processes purify the silicon melt and minimize contamination; and 3. a reduced footprint since the factory space required to house the modular design of these systems is considerably smaller than the equivalent number of conventional casting stations.

This invention may include a three part system for casting silicon. Silicon feedstock chunks can be loaded into a melting area, melted, filtered and accumulated in a ceramic holding vessel at least until an ingot's worth can be processed. The molten silicon can be poured through a chamber interface into a solidification chamber that is detached and runs or completes a solidification cycle independently of the melting and/or holding devices. The melting system can support from about 5 to about 25 solidifiers, such as depending on the power input.

Desirably, the three-stage casting system includes a melting stage, a holding vessel and a solidification chamber. The first two stages may be incorporated in a single unit, but the solidification chamber can be independent and several solidification chambers may be serviced by the same melting and holding system, for example.

The melting stage may include a generally continuous feed of silicon to a relatively small, high power melting area. The precise delivery device or mechanism can take several forms, but the melting area may be comprised of a slotted platform where melted silicon falls through the slots or fingers into a ceramic catch pan where a baffled design filters out both sinking and floating debris before the liquid passes through a heated ceramic conduit into the holding vessel. The fingers of the melting area may be the heaters (for example, silicon carbide or graphite glow bars sleeved with quartz tubing), or the heaters may be a separate system. Desirably, the melting area can be kept continuously at or above the melting temperature of silicon during normal operation.

Concerning the delivery of room temperature or ambient silicon to the melting area, the following solutions can be employed. A many-tined fork-like platform can be loaded with solid silicon. The fork platform can be made of graphite or silicon carbide and held at the end of a long pole. The fork platform can be brought from room temperature through a heat up zone and into the melting area, where the fork's fingers can be lowered through the slotted fingers of the melting area, thus transferring the silicon. The fork platform can then be retracted to load the next batch. Desirably, the melting area is kept under positive pressure to prevent and/or reduce contamination.

In the alternative, a walking beam can deliver the silicon to the melting area. Silicon chunks can be fed into a slanted, rotating tube and slowly make their way to the melting area. Silicon chunks and/or pieces can be loaded vertically in a chute and fall via trap doors into the melting area. Other delivery devices are possible without departing from the scope of this invention.

To get the molten silicon from the catch pan to the holding vessel, either a gravity-fed pour spout can be used, or a more involved system could be used, for example, a ceramic siphon tube could be driven by differential pressure between the melting stage and the holding vessel. In the alternative, a ceramic plunger could be used to push the liquid over a lip at a desired moment.

The holding vessel can be sized to hold more than an ingot's worth of silicon and may have heaters to maintain the silicon in a liquid state, as well as supplying a desired amount of superheating. The holding vessel may include a fused silica vessel that tilts and/or rotates via a hydraulic system to pour the liquid silicon contents through a funnel and a port in a wall of the chamber that links to the solidification chamber. The holding vessel may be fed from multiple melting units, for example.

In the alternative, the melting apparatus and/or the solidifying apparatus may include superheat capabilities. The method of using the melting apparatus and/or the solidifying apparatus may include supplying superheat to the feedstock, such as with heaters.

The solidification chamber (or solidifier) can be a mobile, self-contained unit with its own hook-ups for power, water, gas, and the like. In preparation for the molten silicon, a crucible can be loaded into the solidifier, optionally containing seed crystals and/or a dopant, the crucible vessel can be brought under a controlled atmosphere and heated at least close to the melting point of silicon. The solidifier may move under or next to the chamber with the holding vessel and establish a vacuum-tight link with the holding chamber through, for example, an atmosphere-controlled interlock. The solidifier may receive a load of silicon before de-coupling and moving to another location for the duration of its cycle (cooling), or the melter/holder may move on to the next solidifier. According to one embodiment, the solidifier and method of using may include a vacuum-tight, atmosphere controlled linking of the apparatus with a holding vessel while flowing molten feedstock therebetween.

The solidifier may include a number of unique features. The solidifier may contain a crucible with an empty trough so that near the end of crystal growth, the solidifier may use an elevation mechanism, such as hydraulics to tilt in order to drain off the last of the liquid silicon. The solidifier may have top and bottom heaters, as well as an optional side heater. Cooling of the ingot can occur and/or happen by radiation to a thermally conducting metallic bottom of the solidifier, the view to the metallic bottom can be controlled by an insulation shutter. The metallic bottom may exclude direct water cooling, but may come in contact with an entirely separate water cooled plate in order to effect cooling. The metallic bottom may include copper, aluminum, stainless steel, and/or any other suitable thermally conducting material. The power, water and gas inlets and/or connections may be designed for plug-and-play functionality, as well as hot-swapping. Desirably, mobile hose tubing and/or a flexible lead system allows the movement of the solidifiers and/or other equipment. The solidifier may have a melt detection system mounted over a top and/or a side with a view down to the melt surface. The solidifier may have independent wheels or it may ride on a rail system, possibly powered by a third rail arrangement.

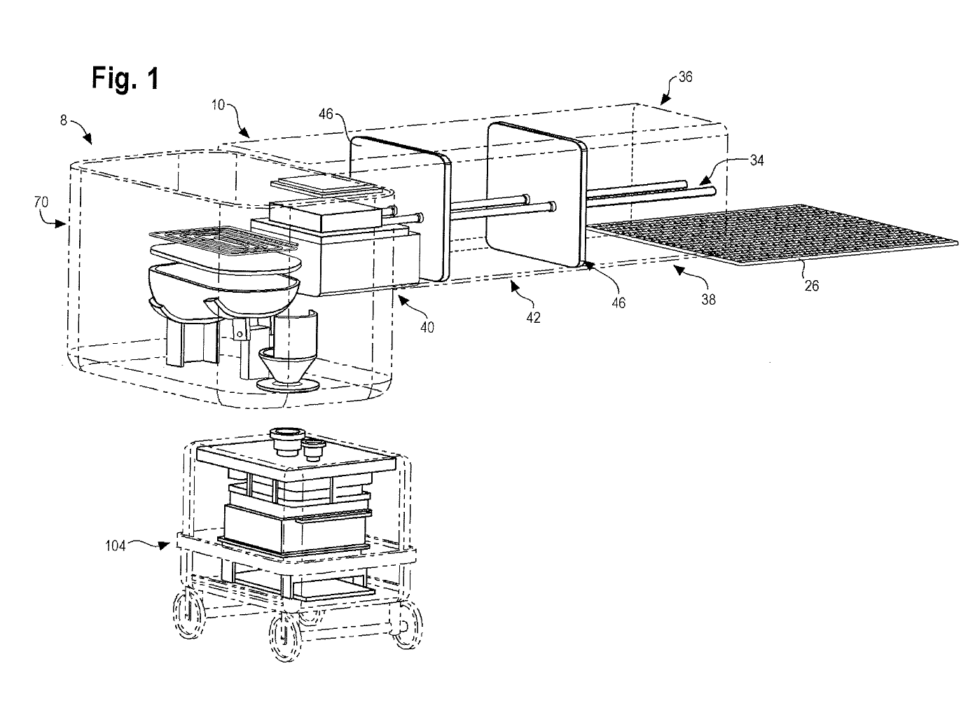

According to one embodiment and as shown in FIG. 1, a three-stage crystallization apparatus 8 may include a melting apparatus 10, a holding apparatus 70, and/or a solidification apparatus 104. The melting apparatus 10 may include a mesh pad 26 for holding solid silicon feedstock. The feedstock may be placed in a loading mechanism with an elongated member 34 that is assisted by a loader support 36. The loading mechanism can be movable between a first position 38 and a second position 40 with an intermediate position 42 between them. The loading mechanism may include one or more doors or environmental locks 46 for keeping a controlled atmosphere.

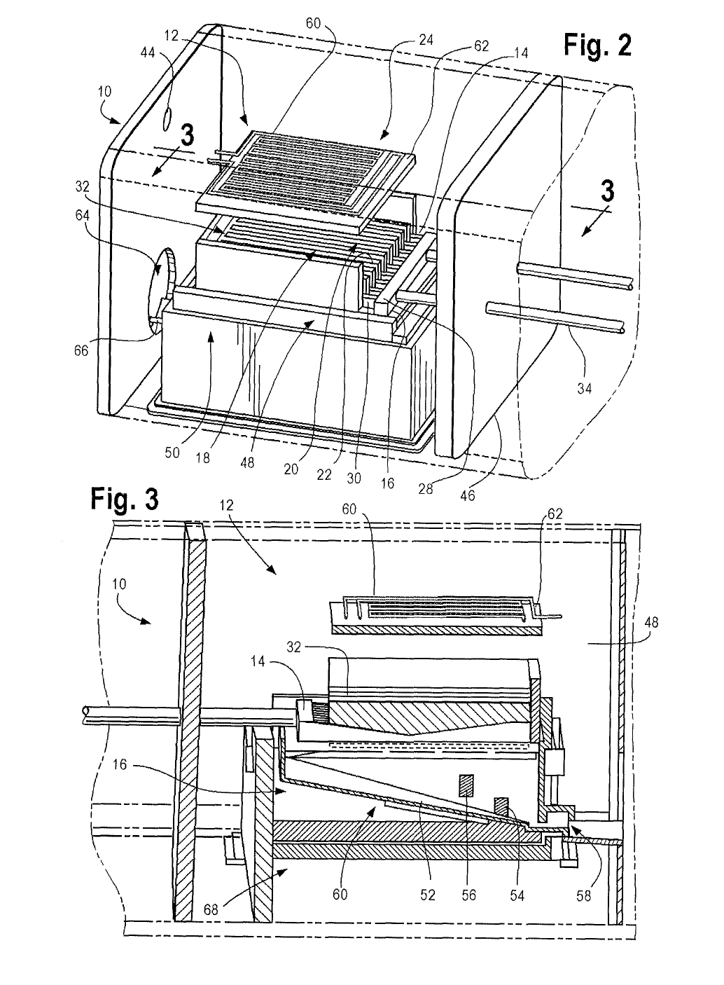

According to one embodiment and as shown in FIGS. 2 and 3, the melting apparatus 10 may include a heat source 12, a delivery device 14, and a catch pan 16. The melting apparatus 10 may also include an inert gas supply 44, an environmental lock 46, a pass through 64, a chute 66, a chamber access door 68, and/or insulation 48.

The heat source 12 may include a slotted platform 18 and rods 20 with slots 22 in between. The heat source 12 may include a cover 24 and a melt zone or area 32. Desirably, the heat source 12 may include a heater 60 with a susceptor 62.

The delivery device 14 may include a fork 28 with tines 30 disposed on an elongated member 34. Desirably, the tines 30 can be lowered between the rods 20 into slots 22 to rest and/or place feedstock in the melting area 32.

The catch pan 16 may include a support structure 50, insulation 48, a sloped bottom 52, a baffle 54, a weir 56, a trough or spout 58, and/or a heater 60.

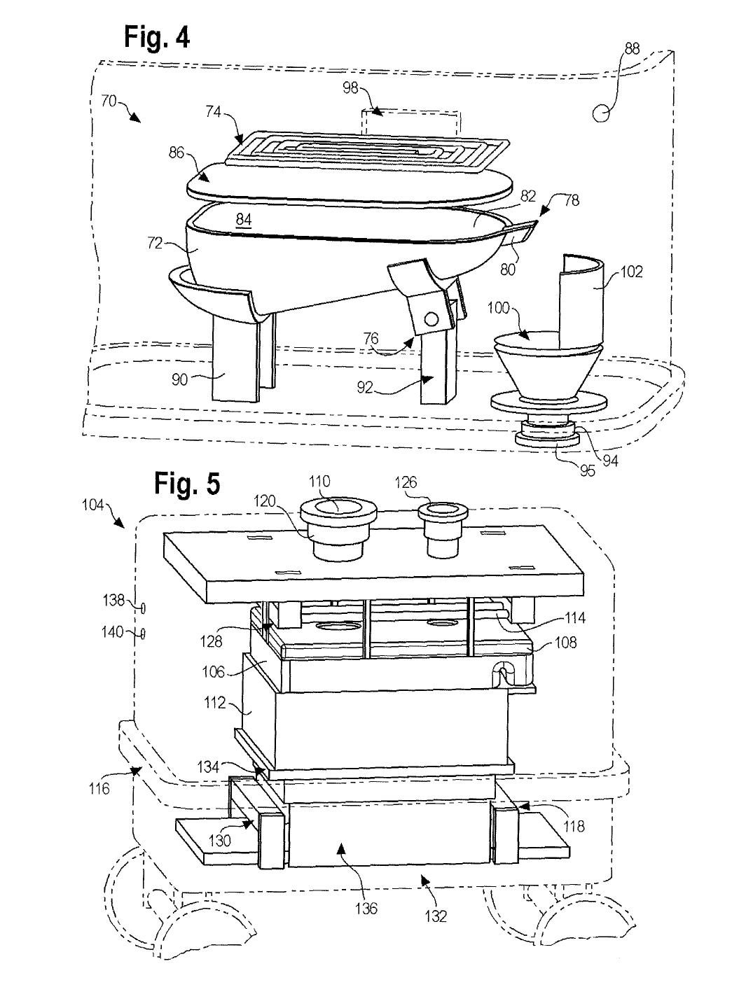

According to one embodiment and as shown in FIG. 4, the holding apparatus 70 may include a holding vessel 72, at least one heater 74, a transfer or tipping mechanism 76, an inert gas supply 88, a trough or chute 94, such as to a solidification zone, an interlock 95, an opening from the melter 98, a funnel 100, and/or a splash shield 102. Desirably, the holding apparatus 70 includes flexible or quick connections 96, such as for utilities.

The holding vessel 72 may include a first depth 82, a second depth 84, an outlet 78, a trough 80, and/or a lid 86. Desirably, the holding vessel 72 may be supported by a fixed leg 90 and/or an adjustable leg 92 in combination with the tipping mechanism 76.

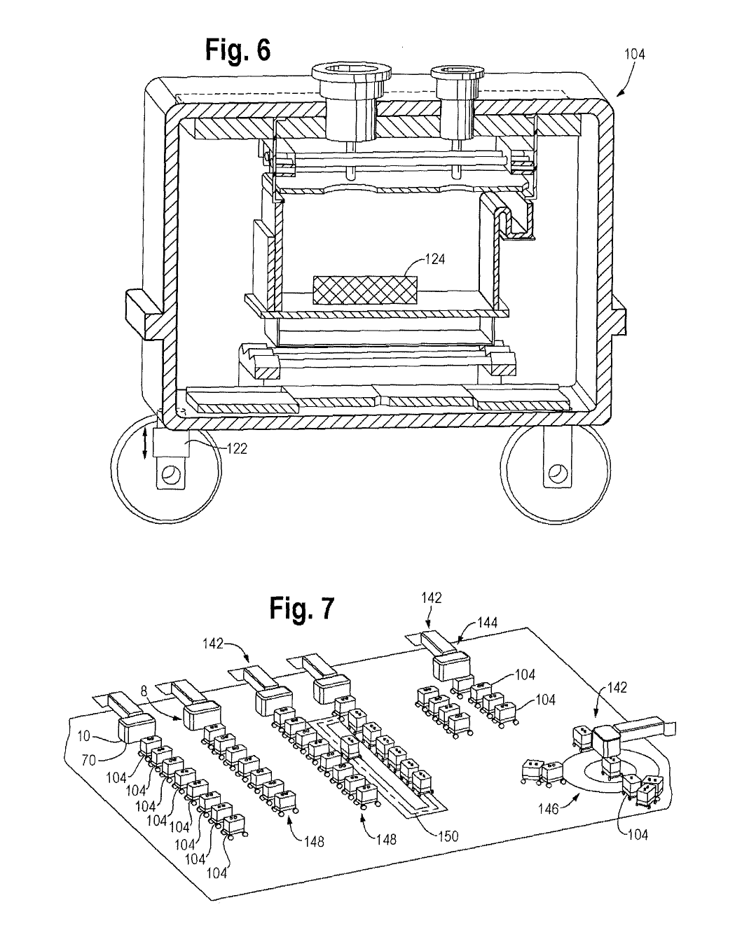

According to one embodiment and as shown in FIGS. 5 and 6, the solidification apparatus 104 may include a crucible or vessel 106, a lid 108, an input port 110, a crucible support 112, a heater 114, a station access point 116, a heat sink 118, and/or a channel 120. The solidification apparatus 104 may also include a tipping mechanism or decanting device 122, such as for up and/or down motion, a seed crystal 124, a melt detection system 126, a top heater 128, a bottom heater 130, a metal plate or bottom 132 (e.g. copper), a heat exchange (hex) block 134, an insulation shutter 136, a vacuum source 138, and/or an inert gas supply 140.

According to one embodiment and as shown in FIG. 7, the three-stage casting apparatus 8 may include a melting apparatus 10, a holding apparatus 70, and/or one or more solidification apparatuses 104, such as to form one or more production lines 142. The melting apparatus 10 and the holding apparatus 70 may combine in a single unit 144. The solidification apparatuses 104 may be in a radially disposed configuration 146 and/or a linearly disposed configuration 148. The apparatuses may travel or roll on wheels and rails. The apparatuses may be powered by a third rail 150, for example.

According to one embodiment, this invention includes a melting apparatus for producing high purity silicon. The apparatus may include a heat source for melting a solid feedstock, a delivery device for supplying the solid feedstock to the heat source, and a catch pan for receiving a molten feedstock from the heat source and flowing the molten feedstock to a holding apparatus and/or for additional processing.

The melting apparatus may include surfaces for contacting the solid feedstock or the molten feedstock made and/or fabricated of high purity components, such as to reduce contaminants. High purity components may include silica, fused silica, and/or any other substance at least partially inert with respect to molten silicon. The melting apparatus may operate substantially continuously and/or at any other suitable cyclability.

The heat source may include any suitable device to melt the solid feedstock, such as using convection, conduction, inductive resistance and/or radiation. The heat source may include resistance heaters, induction heaters, and/or any other mechanism to increase a temperature of a material, such as a solid feedstock and/or a molten feedstock. The heat source may include any suitable size and/or shape, such as a generally rectangular and/or generally square shape.

According to one embodiment, the heat source includes a resistance heater disposed with respect to a top of the heat source. The heat source may include a slotted platform, such as having generally parallel open slots, elongated apertures, and/or slits. Desirably, the slots can be open on one end, such as to allow and/or facilitate removal of a delivery device. The heat source may include a lip or side wall around a hearth area, such as for containing feedstock. The heat source may include one or more heaters. Optionally, the slotted platform includes one or more heaters, such as carbon resistance heaters. The heat source may include a plurality of rods in a generally parallel configuration, such as silicon carbide, graphite and/or any other suitable glow bar type material. Desirably, the rods can be temperature controlled so the solid feedstock melts and falls between them. The rods may be supported at any suitable location, such as on one end generally opposite the delivery device.

Optionally, the rods include a protective cover, such as quartz, fused silica and/or any other suitable material. There may be any suitable number of rods and/or slots, such as at least about 6 rods. The heat source and the surrounding area may be maintained at and/or above the melting point of silicon, such as about 1420 degrees Celsius. Desirably, the heat source has at least one side removed and/or lowered, such as for access of the delivery device to and/or through the rods.

The heat source may include other heaters as desired, such as disposed with respect to one or more sides and/or bottom of the melting apparatus, for example. The heat source may include any suitable amount, location, and/or type of insulation, such as for reducing heat loss. Suitable insulation may include rigidized carbon, carbon fiber composites, alumina or carbon felt, graphite, fused silica, silicon carbide and/or any other substance desirably at least partially inert with respect to molten silicon and with a sufficient thermal conductivity and/or thermal resistivity. The heat source may include one or more melting areas, such as for heating solid feedstock to molten feedstock.

The solid feedstock may include silicon and/or any other suitable material. The solid feedstock may include any suitable size and/or shape. Desirably, but not necessarily, the solid feedstock includes an average particle size of at least 2 centimeters to about 30 centimeters, such as about 5 centimeters. The solid feedstock may be pelletized, crushed to size, classified and/or otherwise sized or sorted. The solid feedstock may include a powder or, in the alternative, exclude a powder.

The most common feedstock form may include the silicon chunk, such as either derived from U-shaped polycrystalline rods or from directionally solidified solar grade silicon. Silicon chunk can be particularly difficult to manage, given the need and desire to minimize contaminants and/or impurities. Suitable materials for contact with the silicon to maintain purity may include fused silica, quartz, silicon nitride and/or silicon carbide, for example. These suitable materials may be brittle and be difficult to form suitable devices and/or tools. For this reason, a typical silicon furnace operation involves hand-placing silicon chunks into a fragile crucible where the silicon can be melted after being loaded into a furnace. According to one embodiment for melting chunk silicon, the process includes first loading the silicon onto a fork or loading tray and then transferring that silicon into the hot zone of the furnace using gentle placement that does not and/or at least reduces possible damage to the melt hearth. The melt hearth may include a flat hearth and/or a contoured hearth or location where the feedstock can be exposed to heat.

Another option for feedstock introduction is to first crush the chunk material into smaller pieces which then may be loaded into crucibles with considerably less concern for the integrity of the ceramics. Unfortunately, crushing can be a difficult process to accomplish in a cost effective manner and in a clean way without causing contamination. The other possibility is to use powder or bead feedstock, such as is produced using a fluidized bed reactor. The bead and/or powder feedstock may allow additional material handling devices and/or techniques. However, the main drawbacks to bead and/or powder feedstock may include 1) availability and 2) difficulty of melting due to the high ratio of surface oxide to volume, for example.

According to one embodiment, once the material is delivered and melted, it is ready to flow through a purifying catch tray or pan into a holding vessel. Desirably, the catch tray or pan performs at least two functions. First, when unmelted silicon escapes into the catch tray, the catch tray may include a weir (i.e. a barrier or baffle) holding a small volume of liquid silicon, for example, less than about 30 kg. To proceed, the liquid silicon can flow under this weir. Solid silicon floats in liquid silicon due to the lower density. Thus, any solid silicon may be trapped by the weir until it melts. Similarly, low density foreign materials also can be aggregated on the surface of the liquid in the catch tray and prevented from flowing through to the holding vessel.

After the liquid silicon passes under the weir, the liquid silicon can then rise up and spill over a second barrier in order to flow into the trough or tundish that can deliver liquid silicon to the holding vessel. This second barrier can make the catch pan system act like a sump, collecting high density particulates at the bottom of the catch pan and preventing them from flowing forward into the holding vessel. Desirably, flowing the molten feedstock with respect to a spill-over barrier may exclude sinking particles or contaminants.

Because of the accumulation of impurities and foreign particles over time, the catch pan can need to be purged occasionally of floating and/or sinking items, which may be accomplished using a drain or by changing out the catch pan. The catch pan drain may draw material from a side, a bottom and/or any other suitable location. Desirably, but not necessarily, the drain can be operated during the casting process.

Optionally, the apparatus may include a holding or staging area for the solid feedstock, such as a mesh holding silicon chunks. The solid feedstock may be loaded on the delivery device by any suitable manner, such as scooping, shoveling, manually placing, robotically placing, stacking, arranging, and/or any other process to transfer the silicon feedstock. The apparatus and a corresponding method may include loading the fork with a robot under an inert atmosphere connected with respect to a hot zone, such as without an environmental lock, for example.

The delivery device may include any suitable apparatus and/or mechanism for supplying and/or delivering a solid feedstock to and/or with respect to the heat source. The delivery device may include a walking beam, a rotating tube, a rotary feeder, a vibratory feeder, a chute and door mechanism, a moving tray, a pushing bar, and/or any other metering system. Desirably, the delivery device includes variable speeds, such as for supplying additional solid feedstock to the heat source.

According to one embodiment, the delivery device includes a fork or fork loader disposed at an end of one or more elongated members or poles. The fork and/or rake includes a plurality of generally parallel tines, such as for supporting one or more pieces of the solid feedstock. The fork may include any suitable number of tines and have any suitable length. Desirably, but not necessarily, each of the tines corresponds to one slot in the heat source. A spacing of the tines may allow passing the tines between one or more slots in the heat source, for example. The tines of the fork may include any suitable configuration, such as a bend about half of a length of the tine to form a generally concave location. The generally concave location may assist and/or aid in holding or resting the feedstock on the loading mechanism, such as preventing the feedstock from rolling off the fork during movement.

The delivery device may include two elongated members, such as to prevent and/or reduce lateral tipping and/or twisting. The delivery device may include a loader support, such as for delivery of the feedstock.

The delivery device may include the ability to move forward or backward, and/or up or down, for example. The fork can be movable and/or positionable between a first position or a first location, such as for loading the solid feedstock, and a second position or a second location, such as for delivering the solid feedstock to the heat source. Desirably, but not necessarily, the fork is movable to an intermediate position or middle location, such as for heating the solid feedstock above ambient temperature or to dry, preheat and/or degas the solid feedstock.

According to one embodiment, the melting apparatus includes at least one inert gas supply for displacing contaminants from the apparatus. Desirably, the oxygen is displaced from the system by the inert gas, such as to reduce and/or prevent oxygen attack of the silicon and/or the insulation. Desirably, the melter can work in one of two ways for normal operation. Either material can be introduced to a load lock which is pumped to a reasonable vacuum (such as about less than 0.1 mBar) and then back filled with an inert gas, or the material can be dumped into an inert enclosure, loaded by robot or automation device onto the delivery device and then passed into the hot zone through a tunnel with an inert gas flowing out of it. The inert gas can include any suitable substance, such as nitrogen, argon, xenon, helium, and/or any other relatively, stable molecule with respect to molten silicon and/or other casting materials or insulating materials.

The delivery device may include an environmental lock and/or an interlock door, such as one or more doors or barriers to keep and/or maintain the inert or controlled atmosphere. Desirably, the environmental lock includes at least two doors with a zone in between.

The catch pan may include any suitable size and/or shape. Desirably, the catch pan at least generally aligns with and/or conforms to a bottom of the heat source. The catch pan may be generally rectangular and/or square. The catch pan may include a sloped bottom, such as for draining the molten feedstock. Desirably, the catch pan includes at least one baffle, weir, and/or other flow modifying device, such as for filtering and/or preventing unmelted feedstock from flowing to the next processing step, followed by a spill-over barrier to inhibit heavy precipitates from proceeding. In the alternative the baffle and/or weir individually and/or in combination provide a desired residence time and/or volume. The baffles may include one or more drain holes at the bottom, such as to prevent a solid block of feedstock from forming at an end of a casting run, for example.

According to one embodiment, the catch pan includes a pour spout, a trough, a siphon tube, a plunger, a tundish and/or any other suitable transfer device. The trough may be open ended, such as having flow directly from the end. In the alternative, the trough may include an end cap and a hole or aperture disposed near the end cap in a bottom, such as having flow through the hole. The catch pan may include one or more chamber access doors, such as located on a bottom of the catch pan or receiving dish. The flow out of the catch pan and any trough or tray is desirably designed so that the exit orifice allows plug-flow conditions for the exit stream instead of the less predictable sheet or drip flow conditions.

The catch pan may include any suitable insulation and/or support structure, such as on the sides. The catch pan may further include any suitable heaters, such as a heater disposed below the sloping surface of the catch pan to keep the feedstock molten. The catch pan may also include a pass through, such as across or through insulation and/or a chute to a holding vessel, for example.

According to one embodiment, this invention includes a method of melting a solid feedstock for high purity silicon. The method of melting may include a step of providing a solid feedstock, a step of supplying the solid feedstock with a delivery device to a heat source, the step of melting the solid feedstock with the heat source, and the step of receiving a molten feedstock from the heat source in a catch pan for flowing the molten feedstock to further processing or staging.

Melting includes increasing a temperature of a material to at or above a melting point of the material. Melting may include a state of substantial softening and/or changing from a generally solid or non-flowing state to a generally liquid or flowing state. The solid feedstock may include any suitable material, such as silicon that has at least been partially refined from an oxide starting material. The melting may include using resistance heaters, induction heaters, and/or any other suitable device. The melting step may include contacting the solid feedstock with a plurality of rods and flowing the molten feedstock through at least one slot.

Providing refers to supplying and/or preparing in advance. According to one embodiment, the step of providing or supplying includes placing one or more pieces of the solid feedstock on a fork at a first position, moving the fork by an elongated member to a second position with respect to the heat source. The fork may be disposed at an end of the elongated member. The method may include lowering at least one of the tines of the fork into one or more slots of the heat source to place the solid feedstock on fingers of the heat source resulting in the feedstock resting on the fingers and/or rods. The method may include withdrawing or pulling back the fork from the heat source, such as in a generally rearward and/or combined rearward-upward motion. Optionally the fork may be used to contact and/or push the solid feedstock into contact with the rods, such as by tapping from the top.

The step of moving may include passing through and/or opening one or more environmental locks and/or doors. The method may include warming the solid feedstock to above ambient temperature in an intermediate position, such as to remove moisture content. Desirably, the method includes flowing and/or supplying an inert gas to at least a portion of the apparatus to prevent impurities and/or displace oxygen.

In the alternative, the method may include a configuration where the delivery device includes a walking beam (periodic generally linear motion), a rotating tube (may include drum flights and/or baffles), a rotary feeder (airlock), a vibratory feeder (magnetically driven), a chute and door mechanism (trap doors optionally with a zigzag configuration), a moving tray, a pushing bar, and/or any other suitable device.

The method may include the step of receiving a molten feedstock or generally liquid material from the heat source or heaters in a catch pan, such as for flowing the molten feedstock to further processing or staging including holding, solidifying or casting. Desirably, the step of receiving includes flowing down an incline. The receiving may include flowing the molten silicon with respect to a baffle or a weir to filter or stop a piece of floating unmelted feedstock, such as unmelted feedstock that may have slipped through the slot. In the alternative, the method includes transferring the molten feedstock from the catch pan to one or more holding vessels.

According to one embodiment, the step of transferring includes flowing and/or directing the molten feedstock through and/or across a pour spout, a siphon tube, a plunger, a trough, a tundish and/or any other suitable device, such as to a holding apparatus.

According to one embodiment, this invention includes a holding apparatus as part of the production of high purity silicon. The holding apparatus may be designed to accumulate melted silicon in a high purity environment, maintain that bath at a specific temperature and then deliver a full batch of silicon to a solidifying apparatus in a short amount of time. The holding apparatus may include a holding vessel with an outlet for receiving a molten feedstock, at least one heater, and a tipping or a transfer mechanism for flowing the molten feedstock to further processing or staging.

The holding vessel may include any suitable size and/or shape, designed to contain the holding crucible and to allow the in-flow of material from a melter and the outflow of material to a further location or process. The holding vessel or crucible may include any suitable material, such as fused silica. The holding crucible may include a first end having a depth and a second end having an increased depth, and may also have an associated lid to help reduce contamination. The depth may be any suitable dimension and the increased depth may be any suitable dimension, such as at least about double the depth of the first end, for example. In the alternative, the holding crucible and/or container includes the same depth with respect to any location within the holding vessel. The holding crucible may be generally rectangular, square, oblong, football-shaped and/or at least somewhat egg-shaped. It should desirably have a spout or exit hole to allow the controlled pour-out of its material, and it should be sufficiently supported to ensure mechanical integrity of the crucible, e.g. by a carbon composite support structure.

The holding vessel may include one or more outlets, such as a funnel, a spout, a trough, a tundish, a port through a wall of the holding vessel, and/or any other suitable device for removing or draining the molten feedstock. The holding apparatus may include at least one inert gas supply, such as for displacing oxygen from the process. The holding apparatus may include an opening, such as in fluid communication with the melting apparatus and/or the catch pan.

The transfer or tipping mechanism may include any suitable device, such as a hydraulic lift, a pneumatic lift, a mechanical lift, a screw, a scissor jack configuration and/or any other mechanism to raise and/or lower at least one side of the holding apparatus. According to one embodiment, the tipping mechanism includes a first generally fixed leg and a second adjustable leg to change a height of an end of the holding vessel, such as buy lowering and/or raising one end. The legs may cradle and/or otherwise support the holding vessel. In the alternative, the entire holding apparatus may be used to drain the holding vessel, such as by tilting and/or tipping the entire assembly.

Desirably, the transfer mechanism includes an interlock, such as to prevent actuation without proper connection and/or fluid communication with a solidification vessel.

The holding apparatus may further include a spout, a funnel, a splash shield, a trough, and/or any other suitable device for transfer and/or flow of a molten feedstock, such as from the holding vessel to a solidification apparatus. The holding apparatus may include a dopant source.

According to one embodiment, in order to mitigate the potential for silicon spillover or escape during these various melting, holding, solidification and transfer processes, it is desirable to use a system of catch receptacles, trays and/or liners located below potential spill paths throughout the system. Preferably, the catch receptacle will be composed of a material that is not soluble in molten silicon, does not outgas at high temperature and can be manufactured to be water-tight. One such material may include carbon-fiber composite, which can be molded into suitable shapes for spill containment. The melting apparatus, the holding apparatus, and/or the solidification apparatus may include any suitable number, size, and/or shape of catch receptacles or spill liners. The method of using the apparatuses of this invention may include capturing a molten feedstock or melted silicon spill and/or release outside the ordinary processing path, such as with a catch receptacle. Any of the apparatuses of this invention may include a carbon-fiber composite catch receptacle for containing spills of the molten feedstock.

According to one embodiment, the holding apparatus and/or the melting apparatus includes one or more portable and/or mobile devices, making it movable between locations with flexible connections, quick connections and/or quick disconnects for utilities. Quick connections generally do not require additional tools to make connections, such as without a leak. Quick connections may include manual and/or automatic shutoff valves, such as to prevent spillage when disconnecting. Quick connections broadly may include electrical, cooling water, inert gas, hydraulic, pneumatic, instrumentation, and/or any other suitable utility and/or process connection.

Alternately, the connections of any moving part of the apparatus can be configured in a flexible way allowing the apparatus to move without disconnecting its utilities. Some embodiments describe the use of quick connections with the idea that the solidifier would be able to operate by disconnecting from its utilities for a brief time while it moves over to the melter to receive a charge of silicon. Ideally, a disconnect time should not last more than about five minutes to prevent overheating of the vessel, for example. Disconnecting utilities can be convenient when the design calls for a significant travel distance for the solidifier. If only small travel distance is involved, then flexible connections can be feasible. Likewise, in an embodiment where the melter and holder may move as a unit (unitized apparatus) to supply static solidifiers, it may be desirable to supply the melter/holder with utilities in a flexible configuration, allowing it to be supplied continuously during operation. This flexible configuration may be accomplished with a third rail configuration for power (assuming that it glides along two other rails), flexible water supply lines, pipes, and/or hoses, and a resident vacuum pump (e.g. on the moving platform that includes the vessels).

According to one embodiment, this invention includes a method of using a holding apparatus as part of the production of high purity silicon. The method of using the holding apparatus may include the step of receiving a molten feedstock into a holding vessel, the step of maintaining the molten feedstock at or above a feedstock melting point, and/or the step of transferring the molten feedstock through an outlet.

Desirably, but not necessarily, the step of maintaining includes superheating the molten feedstock. Superheating includes adding and/or increasing the internal energy (sensible heat) of the material above the melting point, such as about at least 5 degrees above, and not more than about 100 degrees above the melting point. Superheated materials may be useful for subsequent transfers and/or processing to maximize yields and/or prevent blockages when being placed or transferred through tunnels or areas having a temperature below the melting point of silicon. In the alternative, superheated materials may melt a portion of a seed crystal in a solidification apparatus.

According to one embodiment, the step of receiving occurs on at least a generally continuous basis and the step of transferring occurs on at least a generally periodic basis.

The step of transferring may include tilting the holding vessel with a tipping mechanism, for example. The method may include the step of flowing an inert gas to remove contaminants from the holding apparatus, as discussed above. Specifically, a fresh supply of inert gas is preferably supplied at one end of the holding vessel and flows over the surface of the melted volume. Desirably, a lid on the holding vessel helps contain and direct this flow to prevent the intermixing of ambient gases. Finally, it is desirable to exhaust the inert gas swept over the silicon as quickly and directly as possible after its exit from the far side of the crucible in order to capture any SiO molecules evaporating from the melt. Removing SiO can be beneficial because the SiO molecules will react with other furnace components, decreasing their lifetime and, in turn, creating other gases that may be impurity sources for the silicon. The same gas control configuration may be desirable in the solidifier.

According to one embodiment, this invention relates to a solidification apparatus for producing high purity silicon. The solidification apparatus may include a casting crucible or casting vessel for receiving a molten feedstock from a trough, at least one heater, and/or at least one heat sink.

The crucible may include any suitable size and/or shape, such as a generally square shape, a generally rectangular shape and/or a generally round shape. The size of the casting crucible may be the size of the final cast silicon ingots. Optionally, the crucible or the vessel may include a trough and/or a channel for decanting and/or removing impurity laden material during solidification, such as before the top section becomes a solid. In the alternative, the crucible includes a spout and/or a V-shape to pour and/or decant the impurity laden material, such as into a scrap container. The decanting process may be further assisted with the use of a wiper and/or rake, such as moved across and/or with respect to a surface of the crystalline material.

Decanting and/or pouring off of the impurity laden material before it solidifies may reduce the impurities of the finished ingot, for example by preventing fast diffusing impurities that have been segregated to the top from moving downwards into the solid silicon product during cooling. The segregation of impurities (purification of silicon) into the liquid phase can be a natural part of a good directional solidification, since most impurities (metals, carbon, nitrogen and some dopants) have a low solubility in crystalline silicon and collect and/or concentrate in the remaining molten phase. Once the impurities are moved to the top, it can be advantageous to remove a portion of the molten material, such as 0.1-10% of the total silicon volume, where the ratio of impurities in this removed material to the ingot as a whole can be from about 2× to about 10,000,000×.

The solidification apparatus may include a decanting device to tilt the crucible or vessel during solidification. The decanting device may include the devices as generally discussed above with respect to the tipping mechanism. In the alternative, the decanting mechanism includes rolling the solidification apparatus and/or station up an incline or hill to change the angle of the crucible and cause the decanting, such as into a channel. The solidification apparatus may include a vacuum-tight interlock dock/undock.

According to one embodiment the solidification apparatus may include at least one seed crystal disposed with respect to a surface of the crucible, such as on a bottom and/or one or more sides. Optionally, the seed crystal may include one generally uniform orientation and/or may include a tiled arrangement or differing orientations, for example.

According to another embodiment, a method for solidifying silicon involves covering the bottom of the crucible and at least one wall of the crucible with crystalline silicon seed material to produce an ingot that has advantaged crystallinity. Desirably, all four walls can be lined with seed crystals together with the bottom. The crucible with the seed materials can be loaded into the solidifying vessel and form a silicon cup. Once attached to the liquid silicon source, liquid silicon can be poured in to this silicon cup. In this way, contact of liquid silicon with the crucible release coating is minimized, while the nucleation of random grains is eliminated, resulting in an improved and/or nearly perfect crystalline ingot, for example. The sides and bottom of the ingot can be cut off and placed in a new crucible for multiple uses. The superheating of the liquid silicon melts back a small proportion of the seed material before solidification begins, for example. Solidification may proceed by removing heat from one or more sides of the crucible. The method may include placing seed crystals at least substantially to cover a bottom or at least one side of the crucible. The method may include placing seed crystals at least substantially to cover a bottom and all internal sides of the crucible.

According to one embodiment, the melter, holding vessel and/or solidification apparatus may include one or more detection systems or measurement view ports, such as a port to optically inspect the casting process, a thermocouple, a temperature probe, a portable thermocouple, an infrared camera, a level device, a dip rod, a float, a pyrometer, a video camera, a laser detection device and/or any other suitable device.

Desirably, the solidification apparatus includes a portable device movable between locations and includes flexible or quickly detachable connections for utilities, as discussed above with respect to the holding apparatus. Optionally any of the apparatuses of this invention may include a mobile configuration, such as having wheels that may or may not need a track or guide. The apparatuses of this invention may include a suitable driving force, such as an electric motor for moving the wheels.

The solidification apparatus and/or station may include any suitable number of heaters, such as wherein the at least one heater includes a top heater, a bottom heater, and/or a side heater. It is preferable to employ resistive heating elements for reasons of safety and operational simplicity, for example. The solidification apparatus may include any suitable crucible support and/or insulation. The solidification apparatus may include a dopant source and/or mechanism. The solidification apparatus may include one or more inlet and/or input ports, such as located in a top and/or side of the solidification apparatus.

According to one embodiment, the heat sink includes a thermally conducting metallic plate disposed and/or located with respect to a bottom of the crucible. Desirably, the heat sink is in thermal communication with the crucible and/or the molten feedstock, such as for removing a heat of fusion from the feedstock. The solidification apparatus may include a heat exchange block (Hex Block), a metallic bottom, a gas circulating heat exchanger, and/or an insulation shutter.

The solidification apparatus may further include a vacuum source and/or an inert gas supply. Desirably, the vacuum source may be applied, such as during transfer processes and/or operations. Desirably, the inert gas supply may be applied, such as during solidification, for example. The solidification apparatus may include one or more station access points and/or may be mounted on wheels and axles.

According to one embodiment, this invention includes a method of solidifying a molten feedstock for producing high purity silicon. The method of solidifying may include the step of providing a molten feedstock, the step of receiving the molten feedstock in a crucible, the step of providing heat to the molten feedstock with a heater to control a temperature within the crucible, and the step of cooling the feedstock from at least a bottom to crystallize the molten feedstock. The cooling may also take place through one or more sides and/or the top.

The step of receiving includes flowing, pouring and/or transferring, molten feedstock, such as from a melting apparatus or a holding apparatus to a crucible or a vessel. The molten feedstock may include being at the melting point and/or include a sufficient amount of superheat. Superheat includes the amount of energy above the melting point of the solid, for example.

The method of solidifying may include vacuum linking the solidification apparatus with at least a portion of a holding vessel, such as while flowing molten feedstock between the vessels and/or adding an inert gas.

The method of solidification may include moving a solidifying apparatus from a holding apparatus or melting apparatus to a location for solidification. Desirably, but not necessarily, the method may include doping the molten feedstock with a dopant, such as with a dopant source and/or mechanism. Alternately, the silicon may be already doped. The method of solidification may further include the step of crystallizing a solidified product in the presence of seed crystals, such as to yield and/or make multicrystalline silicon, monocrystalline silicon, near monocrystalline silicon, geometric multicrystalline silicon, multicrystalline silicon and/or any other suitable form or orientation.

According to one embodiment, this invention includes an apparatus for producing high purity silicon, such as a three-stage device. The apparatus may include a melting apparatus for melting a solid feedstock to a molten feedstock, a holding apparatus for receiving the molten feedstock from the melting apparatus, and at least one solidification apparatus for solidifying the molten feedstock into a solid product. This invention may include an integrated apparatus including at least a separate melting stage, a separate solidification stage and/or optionally a separate holding stage. The invention includes a two-stage process and more desirably includes a three-stage device and process for casting materials, such as high purity silicon.

According to one embodiment the melting apparatus includes a fork delivery device for placing the solid feedstock over a slot in a heat source. According to one embodiment, the holding apparatus includes a holding vessel and a transfer or tipping mechanism. According to one embodiment, the solidification apparatus includes a crucible, a heater, and a heat sink. The integrated apparatus may include at least one inert gas supply, such as for displacing contaminants from the apparatus.

In the alternative the melting apparatus and the holding apparatus combine in a single unit or device. According to one embodiment, at least one of the melting apparatus, the holding apparatus, or the at least one solidification apparatus includes a portable device movable between locations and/or includes quick connections for utilities. Desirably the melting apparatus and/or the holding apparatus include a mobile single device. In the alternative the solidification apparatus includes a mobile device. More than one melting apparatus can supply molten feedstock to the same holding apparatus. Desirably, at least five solidification apparatuses can be filled from the same holding apparatus. Any suitable number and/or combination of apparatuses are within the scope of this invention.

According to one embodiment, the melting apparatus operates in a generally continuous mode, the holding apparatus operates in a generally semi-batch mode, and the solidification apparatus operates in a generally batch mode. Continuous includes producing material in an at least relatively constant flow. Semi-batch includes producing material in an at least relatively periodic flow, such as having a uniform and/or a non-uniform flow. For example, material may be received continuously but doled out discretely, or vice versa. Batch includes having a relatively intermittent flow, such as having flow on demand.

According to one embodiment, each solidification apparatus can move or be moved with respect to the melting apparatus or the holding apparatus. In the alternative, the melting apparatus and/or the holding apparatus can move or be moved with respect to each solidification apparatus, such as where each solidification apparatus remains generally fixed and the melting apparatus or the holding apparatus move to supply each solidification apparatus.

According to one embodiment, the melting apparatus, the holding apparatus and each solidification apparatus include a different device from others devices, such as having three discrete stages for the crystallization process. In the alternative, the melting apparatus combines with the holding apparatus to form a unitized device.

Desirably, but not necessarily, A volume of a holding vessel in the holding apparatus exceeds or is larger than a volume of a crucible in the solidification apparatus, such as by about a factor of at least 1.5×, at least 2.0×, at least 5.0×, and/or at least 10.0×.

The arrangement of the melting apparatuses, holding apparatuses and/or the solidification apparatuses may include any suitable configuration of one or more of each device. According to one embodiment, each solidification apparatus can be disposed and/or arranged generally radially or in a circle with respect to the melting apparatus and/or the holding apparatus. In the alternative, each solidification apparatus can be disposed and/or arranged generally linearly or in a row with respect to the melting apparatus and/or the holding apparatus. The line, row or train of solidification apparatuses may move and/or index forward one at a time to be filled from the holding apparatus, for example. Other arrangements of series and/or parallel configurations of the various equipment pieces and/or apparatuses are within the scope of this invention.

According to one embodiment, this invention includes a method of producing high purity silicon in a three-stage apparatus. The method may include the step of providing a solid feedstock, loading the solid feedstock into a melting apparatus, the step of melting the solid feedstock in the melting apparatus to a molten feedstock, and/or the step of transferring, flowing and/or pouring the molten feedstock to a holding apparatus. The method may include the step of flowing, transferring, and/or pouring the molten feedstock into a solidification apparatus from the holding apparatus, and/or the step of solidifying the molten feedstock to a solid product in a crucible of the solidification apparatus.

The method may include flowing or blowing an inert gas through at least one of the melting apparatus, the holding apparatus and/or the solidification apparatus, such as to displace impurities. The method and/or the apparatus may include fresh inert gas that sweeps across a surface of silicon in exposed areas before it exhausts from the apparatus. Alternately, the inert gas may be captured and/or recycled.

According to one embodiment, the flowing of the molten feedstock occurs with a vacuum sealed tunnel between the holding apparatus and the solidification apparatus.

The method may include moving the solidification apparatus to allow a second solidification apparatus to receive the molten feedstock, such as from the holding apparatus. In the alternative, the method may include moving at least one of the melting apparatus or the holding apparatus with respect to a plurality of solidification apparatuses, such as generally rotating to a plurality of radially disposed solidification apparatuses. The method may include moving at least one of the melting apparatus or the holding apparatus with respect to a plurality of solidification apparatuses, where the moving may include generally locating with respect to a plurality of generally linearly disposed solidification apparatuses.

The melting apparatus may be periodically and/or relatively continuously charged with the solid feedstock, such as by the delivery device. The melting may occur in a relatively constant manner with heat input to the solid feedstock. The holding apparatus may provide a buffer and/or surge volume for the flow of the molten feedstock. The holding apparatus may supply one or more solidification apparatus, such as at a generally ratable capacity and/or flowrate. The dedicated apparatuses of this invention may provide a more pure solid product, with a higher throughput or capacity.

According to one embodiment, the method may include making utility connections between a utility supply and the melting apparatus, the holding apparatus and/or the solidification apparatus. The method may include removing impurities from the molten feedstock in the crucible, such as by decanting a top molten remainder into a channel, for example. Desirably, the top molten remainder includes a higher concentration of impurities and can be removed before the higher concentration of impurities then diffuses and/or migrates into the solid product, such as during cooling.

According to one embodiment, the method may include powering and/or electrifying at least one of the melting apparatus, the holding apparatus, and/or the solidification apparatus with a third rail or power supply. Desirably, the third rail allows for movement of the apparatus to one or more locations. The method may include moving an apparatus while connected to a flexible supply, such as for utilities and/or process connections with a hose, and/or other suitable coilable, bendable conduit.

According to one embodiment, this invention includes a high purity silicon ingot made by a three-stage method (melting, holding, and solidifying). The method includes the step of providing a solid feedstock, the step of loading the solid feedstock into a melting apparatus, the step of melting the solid feedstock in the melting apparatus to a molten feedstock, the step of transferring the molten feedstock to a holding apparatus, the step of flowing the molten feedstock into a solidification apparatus from the holding apparatus, and the step of solidifying the molten feedstock to a solid product in a crucible of the solidification apparatus.

The method of making the ingot may exclude drawing, pulling, spinning, and/or rotating silicon, such as done with the conventional CZ of FZ processes. The ingot may include primarily silicon including multicrystalline silicon, monocrystalline silicon, near monocrystalline silicon, geometric multicrystalline silicon, and/or any other suitable structure. Desirably, the ingot may be substantially free from radially distributed and/or oriented impurities and/or defects. According to one embodiment, the ingot includes a carbon concentration of about 2×10¹⁶ atoms/cm³ to about 5×10¹⁷ atoms/cm³, an oxygen concentration not exceeding 7×10¹⁷ atoms/cm³, and a nitrogen concentration of at least 1×10¹⁵ atoms/cm³.

According to one embodiment, this invention may include a melting apparatus including direct electric resistive melting, such as a continuous melter. Electrical energy can be applied directly to the material to be melted allowing easy integration into a continuous melting system while maintaining high melting efficiencies, simplifying heater design, and/or material supply. Desirably, the electric arc melting allows silicon chunks of arbitrary size to be loaded and melted while maintaining high purity. The melter may include two plates of an electrically conductive material (such as graphite or SiC) separated by a gap or by an insulating material (such as Si0₂). The two plates may be connected to an electrical circuit such that the plates are at opposite polarities. The plates can be arranged at an angle to one another forming a “V” shape when viewed from the side. The open ends of the V could be enclosed with electrically insulating materials, or the electrically active elements could be mounted almost entirely within an electrically insulating block, with just one face of each exposed. Alternately, the fingers of the other melting apparatus may be placed in direct contact with the silicon and biased in a way that would pass current through the silicon bridging the fingers.

According to one embodiment, this invention may include a support for the holding vessel and/or the crucible that includes carbon-carbon (C-C), reinforced carbon-carbon (RCC), carbon-fiber-carbon (CFC), high temperature composites, alloys, ceramics, metals, and/or other suitable substances. Desirably, the support includes sufficient structural members even if the holding vessel or the crucible deforms or becomes pliable at elevated temperatures while containing the molten feedstock, such as at least about 500 kilograms of liquid silicon at or above about 1420 degrees Celsius. The support may also include sufficient structural capabilities to allow mechanization, such as tipping the holding vessel to transfer the molten feedstock. The support structure desirably includes a keel with ribs supporting a thin C-C shell or liner that conforms to the crucible shape.

According to one embodiment, the solidification apparatus may include a gas recirculating heat exchanger. The gas recirculating heat exchanger may act as a convective cooling system where cool inert gas is introduced to a heat conductive block in thermal communication with the ingot. The gas may be forced through a diffuser plate and will become heated, for example up to several hundred degrees, based on conductive contact with the cooling block. The hot gas is then pulled out and put through a heat exchanger, where the thermal energy may be converted for use in other applications. The cool gas from the heat exchanger can then be recirculated through the system, for example. The gas recirculating heat exchanger negates the need to radiate heat to a water-cooled chamber wall and may reduce a risk of liquid silicon reaching the water-cooled wall. The gas recirculating heat exchanger may increase a safety factor if a silicon breach and/or spill occurs. Temperature moderation may be accomplished by changing a mass flow rate of gas (in the primary case, argon), by changing the blower speed through variable frequency drive, and/or the like.

The traditional water cooling in the chamber walls raises the water temperature by at most 90 degrees C., which represents low-grade energy that is difficult to recover. The gas recirculating heat exchanger as a non-water primary heat transfer medium may allow high quality heat recovery that could be used for transfer to other media and/or uses, such as steam or high temperature heat transfer fluid for use as secondary power generation and/or waste heat recovery.

According to one embodiment, the heaters used in this invention may include any suitable design, such as a heater body formed from a small diameter graphite piece that can be machined into an efficient radiant heater shape and easily inserted into an electrical connection for use in heating a controlled atmosphere high temperature furnace. Desirably, but not necessarily, a heater design eliminates the single large serpentine elements machined out of a large block. Also desirably, but not necessarily, the heater design eliminates many bolted connections. Each heater or heater element can be slip fit into a water-cooled bus (e.g. made from copper) to provide a taper-lock power connection and can be removed straight out without entering the casting station and/or apparatus.

According to one embodiment, the inert gas and the associated system used in the apparatuses of this invention may include a recirculation system, such as to reduce a volume of make up gas. An inert gas supply may flow to the areas as needed and/or be assisted with vacuum and/or eductors to establish and/or maintain a controlled atmosphere. The inert gas system may include a rebreather, a compressor, a blower, an accumulator, an inflatable bag, and/or any other suitable device, such as to reduce operating costs.

It will be apparent to those skilled in the art that various modifications and variations can be made in the disclosed structures and methods without departing from the scope or spirit of the invention. Particularly, descriptions of any one embodiment can be freely combined with descriptions or other embodiments to result in combinations and/or variations of two or more elements or limitations. Other embodiments of the invention will be apparent to those skilled in the art from consideration of the specification and practice of the invention disclosed herein. It is intended that the specification and examples be considered exemplary only, with a true scope and spirit of the invention being indicated by the following claims.

What is claimed is:

1. A melting apparatus suitable for producing high purity silicon, the apparatus comprising:
a heat source for melting a solid feedstock;
a delivery device for supplying the solid feedstock to the heat source; and
a catch pan for receiving a molten feedstock from the heat source and flowing the molten feedstock to a holding apparatus for further processing.

2. The apparatus of claim 1, wherein surfaces for contacting the solid feedstock or the molten feedstock comprise high purity components.

3. The apparatus of claim 1, wherein the melting apparatus operates substantially continuously.

4. The apparatus of claim 1, wherein the heat source comprises a slotted platform.

5. The apparatus of claim 1, wherein the heat source comprises a flat or a contoured hearth.

6. The apparatus of claim 5, wherein the heat source comprises a plurality of rods in a generally parallel configuration.

7. The apparatus of claim 6, wherein the rods comprise a protective cover.

8. The apparatus of claim 1, wherein the heat source comprises silicon carbide or graphite.

9. The apparatus of claim 1, wherein the delivery device comprises a fork disposed at an end of an elongated member, the fork comprises a plurality of generally parallel tines for supporting the solid feedstock.

10. The apparatus of claim 9, further comprising a spacing of the tines for passing between one or more slots in the heat source.

11. The apparatus of claim 9, wherein the fork is movable between a first position for loading the solid feedstock and a second position for delivering the solid feedstock to the heat source.

12. The apparatus of claim 11, wherein the fork is movable to an intermediate position for heating the solid feedstock above ambient temperature.

13. The apparatus of claim 1, wherein the delivery device is selected from one of the group consisting of a walking beam, a rotating tube, a rotary feeder, a vibratory feeder, a chute and door mechanism, a moving tray, a pushing bar, and combinations thereof.

14. The apparatus of claim 1, further comprising an inert gas supply for displacing contaminants from the apparatus.

15. The apparatus of claim 1, wherein the delivery device comprises an environmental lock.

16. The apparatus of claim 1, wherein the catch pan comprises a sloped bottom for draining the molten feedstock.

17. The apparatus of claim 1, wherein the catch pan comprises a baffle or a weir.

18. The apparatus of claim 1, wherein the catch pan comprises a pour spout, a trough, a siphon tube, a plunger or combinations thereof.

19. The apparatus of claim 1, wherein the heat source comprises a heater disposed with respect to a top of slot openings.

20. A method of melting a solid feedstock suitable for producing high purity silicon, the method comprising:
providing a solid feedstock;
supplying the solid feedstock with a delivery device to a heat source;
melting the solid feedstock with the heat source; and
receiving a molten feedstock from the heat source in a catch pan for flowing the molten feedstock to further processing or staging.

21. The method of claim 20, wherein the supplying comprises:
placing one or more pieces of the solid feedstock on a fork at a first position;
moving the fork by an elongated member to a second position with respect to the heat source, wherein the fork is disposed at an end of the elongated member;
lowering tines of the fork into one or more slots of the heat source to place the solid feedstock on fingers of the heat source; and
withdrawing the fork from the heat source.

22. The method of claim 21, wherein the moving comprises passing through an environmental lock.

23. The method of claim 21, further comprising loading the fork with a robot under an inert atmosphere connected with respect to a hot zone.

24. The method of claim 21, further comprising warming the solid feedstock to above ambient temperature in an intermediate position.

25. The method of claim 20, further comprising flowing an inert gas to prevent impurities.

26. The method of claim 20, wherein the delivery device is selected from one of the group consisting of a walking beam, a rotating tube, a rotary feeder, a vibratory feeder, a chute and door mechanism, a moving tray, a pushing bar, and combinations thereof.

27. The method of claim 20, wherein the melting comprises using resistance heaters, induction heaters, or combinations thereof.

28. The method of claim 20, wherein the melting comprises contacting the solid feedstock with a plurality of rods and flowing the molten feedstock through at least one slot.

29. The method of claim 20, wherein the receiving comprises flowing down an incline.

30. The method of claim 20, wherein the receiving comprises flowing the molten feedstock with respect to a baffle, a weir, or combinations thereof to stop a piece of floating unmelted feedstock.

31. The method of claim 20, wherein the receiving comprises flowing the molten feedstock with respect to a spill-over barrier to exclude sinking particles or contaminants.

32. The method of claim 20, further comprising transferring the molten feedstock from the catch pan to a holding vessel.

33. The method of claim 32, wherein the transferring comprises flowing through a pour spout, a siphon tube, a plunger, a trough or combinations thereof.

34. A holding apparatus suitable for producing high purity silicon, the apparatus comprising:
a holding vessel with an outlet for receiving a molten feedstock;
at least one heater; and
a transfer or a tipping mechanism for flowing the molten feedstock to further processing or staging.

35. The apparatus of claim 34, wherein the holding vessel comprises fused silica.

36. The apparatus of claim 34, wherein the outlet comprises a funnel, a spout, a trough, or port through a wall of the holding vessel.

37. The apparatus of claim 34, wherein the holding vessel comprises:
a first end having a depth and a second end having an increased depth; and
a lid.

38. The apparatus of claim 34, further comprising inert gas supply.

39. The apparatus of claim 34, wherein the tipping mechanism comprises a first fixed leg and a second adjustable leg to change a height of an end of the holding vessel.

40. The apparatus of claim 34, further comprising a spout, a funnel, a trough or combinations thereof to transfer a molten feedstock from the holding vessel to a solidification apparatus.

41. The apparatus of claim 34, wherein the apparatus comprises a portable device movable between locations and comprises flexible or quick connections for utilities.

42. The apparatus of claim 34, further comprising a dopant source.

43. The apparatus of claim 34, further comprising a support for the holding vessel, wherein the support comprises carbon-carbon.

44. A method of using a holding apparatus suitable for producing high purity silicon, the method comprising:
receiving a molten feedstock into a holding vessel
maintaining the molten feedstock at or above a feedstock melting point; and
transferring the molten feedstock through an outlet.

45. The method of claim 44, wherein the maintaining comprises superheating the molten feedstock.

46. The method of claim 44, wherein the receiving occurs on a generally continuous basis and the transferring occurs on a generally periodic basis.

47. The method of claim 44, wherein the transferring comprises tilting the holding vessel with a tipping mechanism.

48. The method of claim 44, further comprising flowing an inert gas to remove contaminants from the holding apparatus.

49. A solidification apparatus suitable for producing high purity silicon, the apparatus comprising:
a crucible or vessel for receiving a molten feedstock from a trough;
at least one heater; and
at least one heat sink.

50. The apparatus of claim 49, further comprising a vacuum-tight interlock dock/undock.

51. The apparatus of claim 49, wherein the crucible or vessel comprises a trough for decanting impurity laden material during solidification.

52. The apparatus of claim 49, further comprising a decanting device to tilt the crucible or vessel during solidification.

53. The apparatus of claim 49, further comprising at least one seed crystal disposed with respect to an interior surface of the crucible or vessel.

54. The apparatus of claim 49, further comprising a melt detection system.

55. The apparatus of claim 49, wherein the apparatus comprises a portable device movable between locations and comprises flexible or quick connections for utilities.

56. The apparatus of claim 49, wherein the at least one heater comprises a top heater and a bottom heater.

57. The apparatus of claim 56, further comprising at least one side heater.

58. The apparatus of claim 49, wherein the apparatus comprises a dopant source.

59. The apparatus of claim 49, wherein the heat sink comprises a metallic plate disposed with respect to a bottom of the crucible.

60. The apparatus of claim 49, further comprising a vacuum source and an inert gas supply.

61. A method of solidifying a molten feedstock suitable for producing high purity silicon, the method comprising:
providing a molten feedstock;
receiving the molten feedstock in a crucible;
providing heat to the molten feedstock with a heater to control a temperature within the crucible; and
cooling the molten feedstock from a bottom or at least one side to crystallize the molten feedstock.

62. The method of claim 61, wherein the receiving comprises vacuum-tight, atmosphere controlled linking of the apparatus with a holding vessel while flowing molten feedstock therebetween.

63. The method of claim 61, further comprising moving a solidifying apparatus from a holding apparatus or melting apparatus to a location for solidification.

64. The method of claim 61, further comprising doping the molten feedstock with a dopant.

65. The method of claim 61, further comprising orienting a solidified product with seed crystals.

66. The method of claim 61, wherein the solidified product is selected from the group consisting of multicrystalline silicon, monocrystalline silicon, near monocrystalline silicon, geometric multicrystalline silicon, and combinations thereof.

67. The method of claim 61, further comprising placing seed crystals at least substantially to cover a bottom or at least one side of the crucible.

68. The method of claim 61, further comprising placing seed crystals at least substantially to cover a bottom and all internal sides of the crucible.

69. An apparatus suitable for producing high purity silicon, the apparatus comprising:
a melting apparatus for melting a solid feedstock to a molten feedstock;
a holding apparatus for receiving the molten feedstock from the melting apparatus; and
at least one solidification apparatus for solidifying the molten feedstock into a solid product.

70. The apparatus of claim 69, wherein the melting apparatus comprises a fork delivery device for placing the solid feedstock over a slot in a heat source.

71. The apparatus of claim 69, wherein the holding apparatus comprises a holding vessel and a tipping mechanism.

72. The apparatus of claim 69, further comprising an inert gas supply for displacing contaminants from the apparatus.

73. The apparatus of claim 72, wherein fresh inert gas sweeps across a surface of silicon in exposed areas before exhausts from the apparatus.

74. The apparatus of claim 69, wherein each solidification apparatus comprises a crucible, a heater and a heat sink.

75. The apparatus of claim 69, wherein the melting apparatus and the holding apparatus combine in a single unit.

76. The apparatus of claim 69, wherein at least one of the melting apparatus, the holding apparatus, or the at least one solidification apparatus comprises a portable device movable between locations and comprises flexible or quick connections for utilities.

77. The apparatus of claim 69, wherein more than one melting apparatus supplies molten feedstock to the same holding apparatus.

78. The apparatus of claim 69, wherein at least five solidification apparatuses are filled from the same holding apparatus.

79. The apparatus of claim 69, wherein the melting apparatus operates in a generally continuous mode, the holding apparatus operates in a generally semi-batch mode, and the solidification apparatus operates in a generally batch mode.

80. The apparatus of claim 69, wherein each solidification apparatus moves with respect to the melting apparatus or the holding apparatus.

81. The apparatus of claim 69, where each solidification apparatus remains generally fixed and the melting apparatus or the holding apparatus move to supply each solidification apparatus.

82. The apparatus of claim 69, wherein the melting apparatus, the holding apparatus and the each solidification apparatus comprise a different device from others devices.

83. The apparatus of claim 69, wherein a volume of a holding vessel in the holding apparatus exceeds a volume of a crucible in the solidification apparatus.

84. The apparatus of claim 69, wherein each solidification apparatus is disposed generally radially with respect to the melting apparatus or the holding apparatus.

85. The apparatus of claim 69, wherein each solidification apparatus is disposed generally linearly with respect to the melting apparatus or the holding apparatus.

86. The apparatus of claim 69, further comprising a carbon-fiber composite catch receptacle for containing spills of the molten feedstock.

87. A method suitable for producing high purity silicon, the method comprising:
providing a solid feedstock;
loading the solid feedstock into a melting apparatus;
melting the solid feedstock in the melting apparatus to a molten feedstock;
transferring the molten feedstock to a holding apparatus;
flowing the molten feedstock into a solidification apparatus from the holding apparatus; and
solidifying the molten feedstock to a solid product in a crucible of the solidification apparatus.

88. The method of claim 87, further comprising flowing an inert gas through at least one of the melting apparatus, the holding apparatus or the solidification apparatus.

89. The method of claim 87, wherein the flowing occurs through an atmosphere controlled interlock between the holding apparatus and the solidification apparatus.

90. The method of claim 87, further comprising moving the solidification apparatus to allow a second solidification apparatus to receive molten feedstock.

91. The method of claim 87, further comprising moving at least one of the melting apparatus or the holding apparatus with respect to a plurality of solidification apparatuses.

92. The method of claim 91, wherein the moving at least one of the melting apparatus or the holding apparatus comprises generally rotating to a plurality of radially disposed solidification apparatuses.

93. The method of claim 91, wherein the moving at least one of the melting apparatus or the holding apparatus comprises generally locating with respect to a plurality of generally linearly disposed solidification apparatuses.

94. The method of claim 87, further comprising making utility connections between a utility supply and the melting apparatus, the holding apparatus or the solidification apparatus.

95. The method of claim 87, further comprising removing impurities from a crucible by decanting a top molten remainder.

96. The method of claim 87, further comprising moving the apparatus on at least two rails while powering at least one of the melting apparatus, the holding apparatus, or the solidification apparatus with a third rail.

97. A high purity silicon ingot made by a three-stage method, the method comprising:
providing a solid feedstock comprising silicon;
loading the solid feedstock into a melting apparatus;
melting the solid feedstock in the melting apparatus to a molten feedstock;
transferring the molten feedstock to a holding apparatus;
flowing the molten feedstock into a solidification apparatus from the holding apparatus; and
solidifying the molten feedstock to a solid product in a crucible of the solidification apparatus.

98. The ingot of claim 97, wherein the method excludes drawing or rotating silicon.

99. The ingot of claim 97, wherein the ingot comprises primarily silicon selected from the group consisting of multicrystalline silicon, monocrystalline silicon, near monocrystalline silicon, geometric multicrystalline silicon, and combinations thereof.

100. The ingot of claim 97, wherein the ingot is substantially free from radially distributed defects.

101. The ingot of claim 97, wherein the ingot comprises a carbon concentration of about 2×10¹⁶ atoms/cm³ to about 5×10¹⁷ atoms/cm³, an oxygen concentration not exceeding 7×10¹⁷ atoms/cm³, and a nitrogen concentration of at least 1×10¹⁵ atoms/cm³.
